(19) United States
(12) Patent Application Publication
(10) Pub. No.: US 2001/0039246 A1
(43) Pub. Date: Nov. 8, 2001

(54) Composition and method for early bloom thinning of fruit trees and controlling cracking of fruits

(76) Inventors: Yousheng Duan, Zibo (CN); Zhiqiang Ju, Zibo (CN); Liye Ju, Zibo (CN); Zhiguo Ju, Wenatchee, WA (US)

Correspondence Address: ZHIGUO JU, 1229 4th St. # B, Wenatchee, WA, 98801, US

(21) Appl. No.: 09/767,591

(22) Filed: Jan. 22, 2001

Related U.S. Application Data
(63) Continuation-in-part of application No. 09/571,764, filed on May 16, 2000.
(60) Provisional application No. 60/205,920, filed on May 22, 2000.
(60) Provisional application No. 60/178,270, filed on Jan. 27, 2000.

(51) Int. Cl. A01N 55/02; A01N 59/20; A01N 59/00

(52) U.S. Cl. 504/121; 504/162; 504/163; 514/499; 424/630; 424/633; 424/634; 424/637; 424/638

(57) ABSTRACT

A composition and method for early bloom thinning of fruit trees and controlling cracking, wherein the composition provides that glyceride type of lipids are effective compounds for bloom thinning of fruit trees and controlling cracking of fruits and the method comprises making an aqueous emulsion with these lipids as active ingredients and spraying the emulsion on fruit trees at appropriate phenophases for blossom thinning or fruit cracking control. The composition further provides that copper compounds act as blossom thinning agents but cause phytotoxicity to trees and a mixture of the said lipid emulsion and copper compounds displays higher thinning effect than each applied alone and does not cause phytotoxicity to trees.

### CROSS-REFERENCE TO RELATED APPLICATIONS

Part of this application claims benefit of U.S. Provisional Application No. 60/205,920, filed May 22, 2000, which claims the benefit of U.S. Provisional Application No. 60/178,270, filed Jan. 27, 2000. This application is also a continuation in part of pending U.S. patent application, Ser. No. 09/571,764, confirmation No. 4848, filed on May 16, 2000, entitled ‘Composition and method for delaying ripening and senescence, controlling storage disorders, and reducing fungal decay in fruits’.

### STATEMENT REGARDING FEDERALLY SPONSORED RESEARCH OR DEVELOPMENT

Not Applicable

### BACKGROUND OF THE INVENTION

1. Field of the Invention

This invention pertains generally to the fields of bloom thinning of fruit trees and controlling cracking of fruits. Glyceride type of lipid compositions, copper compounds, or the combinations of said lipids and copper compounds are provided for these applications.

2. Brief Description of Related Art

(1) Chemical Thinning of Fruit Trees

Chemical thinning is widely practiced in tree fruit production for reducing labor cost, enhancing fruit size, color, and maturity, and ensuring bloom return the next season.

Two types of chemical thinners are currently used and tested for tree fruit production (Byers, 1997, 1999; Looney, 1983; Williams, 1979, 1998). The first one is known as blossom thinner, which comprises caustic or desiccating compounds and is often applied during late blooming period (around 80% full bloom). Examples of such blossom thinners are lime sulfur, sulfcarbamide (Wilthin), pelargonic acid (Thinex), or ammonium thiosulfate (ATS). These caustic compounds burn stigmas and styles of open flowers and thus prevent fertilization and seed formation. The early-opened, fertilized flowers or unopened flower buds are not affected and therefore, can set fruit. Application of these caustic compounds to trees, however, has the following disadvantages: (1) narrow time window. Blossom thinners do not kill unopened flowers and therefore, applying too early may kill the king bloom (which sets larger fruit) and leave the unopened lateral flowers (which set smaller fruit) to set fruit. Timing to remove these lateral flowers by late application, on the other hand, may result in russet on the early-developed fruit or injury to leaves (Williams, 1998; Naegely, 2000); (2) inconsistent results. Since caustic blossom thinners are effective only on already opened but unfertilized flowers, the efficacy of these compounds depends on the percentage of fertilized flowers at application. If most of the opened flowers were pollinated and fertilized, application of caustic blossom thinner at 80% full bloom may produce inadequate thinning. If few opened flowers were fertilized at 80% full bloom, application of caustic blossom thinner at this time may cause over thinning. Therefore, any factor affecting pollination and fertilization may affect the thinning efficacy of these bloom thinners, which makes the results unpredictable (Byers, 1997, 1999; Williams, 1998; Naegely, 2000); and (3) phytotoxicity. Caustic blossom thinners are non-selective to plant tissues and often cause foliage or fruit injury when applied at the recommended phenophases (Byers and Lyons, 1985; Fallahi, 1997; Williams, 1998; McFerson and Schmidt, 1999; Naegely, 2000).

The other type of thinner is a hormonal-type growth regulator such as 1-naphthyl N-methyl carbamate (Carbaryl), benzyladenine (BA), naphthalene acetic acid (NAA) or ethephon (Williams, 1979, 1998). These compounds are applied after full bloom or petal fall and therefore called post-bloom thinner. Post-bloom thinners interfere with normal metabolism of fruit and accelerate fruit abscission (Stopar et al., 1997; Yuan and Greene, 2000). However, post-bloom thinners such as NAA or ethephon sometimes depresses fruit size at the concentration achieving adequate thinning or when applied too late after full bloom (Jones et al., 1983, Scholtens and Westerlaken, 1987). The other disadvantage with these compounds is that fruit growers have no other option but hand thinning once the compounds fail to thin adequately.

In addition to efficacy and phytotoxicity, registration for use is another factor that limits the availability of chemical thinners to fruit growers. For example, Dinitro-ortho-cresol (DNOC), an effective blossom thinner on apples registered in 1989, was removed from the market by the manufacturer because of the high cost of re-registration (Williams, 1998). The future use of 1-naphthyl N-methyl carbamate (Carbaryl), one of the most widely used post-bloom thinners, is uncertain as US EPA decides the fate of carbamate pesticides (Naegely, 2000). In addition, organic fruit production has increased rapidly in recent years, and few chemical thinners meet the standard for organic fruit production.

Therefore, one objective of this invention is to provide a composition and a method that can be used to thin earlier than the currently used blossom thinners on fruit trees. A further objective of this invention is to provide a composition and a method that is non-phytotoxic to fruit trees, safe to beneficial insects and environment, and friendly to user, and therefore, can be used for both conventional and organic fruit production.

Prior arts disclosed that at high concentrations, certain surfactants such as alkaryl polyoxyethylene alcohols (Byers and Lyons, 1982; 1983, 1984), N,N-bis 2-[omega (hydroxypolyoxyethylene/polyoxypropylene)ethyl alkylamine] (Armothin) (Southwick et al., 1996, 1998) could be used as bloom thinners on peach trees. In practice, however, their application has been limited since these surfactants cause phytotoxicity to trees at higher concentrations while at lower concentrations, such as 2% alkaryl polyoxyethylene alcohols (Byers and Lyons, 1982, 1984) or 1% Armothin (Southwick et al., 1996, 1998), these surfactants are not effective thinners. In addition, these surfactants share a similar mode of action with other caustic blossom thinners and therefore, have the same disadvantages.

Both fatty acids and lipids have been used and tested for blossom thinners. Lipids represent a variety of compounds but can be classified into three major groups according to their structures and properties: (1) glyceride type of lipids. Those are compounds formed from glycerol and fatty acids; (2) waxes. Those are esters of long chain fatty acids and long chain fatty alcohols; and (3) terpenoids. Those are formed with five-carbon-building blocks called isopentene. U.S. Pat. No. 5,242,891 discloses that certain fatty acids act as a blossom-thinning agent. But fatty acids are not lipids. U.S. Pat. No. 6,156,703 states that an aqueous emulsion of jojoba oil inhibits fruit setting on a fruit producing plant. This jojoba oil, however, is not a glyceride. It contains more than 97% wax esters, which are derived from one molecule of a long-chain monoethylenic alcohol esterified with one long-chain monoethylenic fatty acid. Essential oils (Mitham, 2000) and cholesterol or plant sterols (U.S. Pat. Nos. 4,613,359 and 4,789,398) have also been tested for blossom thinning on fruit trees. But essential oils, cholesterol or plant sterols belong to the group of terpenoids. Therefore, fatty acids, jojoba oil, essential oils, cholesterol or plant sterols are totally different in form and are not within the scope of the present invention.

It is known that during the mid-1980s, Ostenson (Featherstone, 2000) from Washington State tested and employed a fish oil mixture to thin apples. His mixtures, fish oil (1% to 2%) plus lime-sulfur with a pH of about 10.5 or fish oil plus acid with a pH of 3.5, applied after 80% full bloom, have not been very successful. First, these mixtures, like many other caustic bloom thinners, are harsh and non-selective to plant tissues, and therefore, often cause phytotoxicity to leaves or fruits (Featherstone, 2000). Second, these mixtures give inconsistent thinning results and in some cases, significantly over-thin and russet fruit (McFerson and Schmidt, 1999). Thirdly, both lime-sulfur and acid kill flower and other young plant tissues. While lime-sulfur itself has been used as a thinning agent since the early thirties (Williams, 1979) and both organic and inorganic acids can desiccate plant tissues, fish oil alone was tested to be ineffective in thinning and has not been used as a blossom thinner (Edwards, 1998). Our study also showed that fish oil up to 5% applied at or after 80% full bloom (the recommended application phenophase for fish oil mixture) was not effective in thinning, although the concentration was higher than the recommended concentration (1% to 2%).

It is also known that soybean oil applied once at 10% or twice at 2.5% or 5% at dormant stage kills flower buds and therefore, has been suggested as a tool to thin flower buds on peach trees (Myers et al., 1996; Moran et al., 2000). Its potential as a thinning agent, however, needs further study since its effect on leaf bud survival is not clear. And killing some of the flower buds too early in spring may create excessive risk if a late frost occurs. This is evidenced by the fact that when freezing temperature killed 42% of flower buds on control trees in 1993, bud loss with soybean oil thinning was as high as 92% (Moran et al., 2000). More importantly, killing flower buds at dormant stage is a totally different mode of action in comparison with the present invention.

The other problem associated with fish oil or soybean oil products currently used or under test is their instability in water solution. In the prior arts, fish or soybean oil are formulated with certain surfactants (Myers et al., 1996; McFerson and Schmidt, 1999; Featherstone, 2000; Moran et al., 2000). When diluted with water by vigorous stirring, the oil and surfactant mixture forms an emulsion. This emulsion, however, is unstable and separates easily when applied to trees, which results in uneven distribution of oil on leaf surfaces and causes phytotoxicity to trees. For example, canola oil at 1% spray causes shotholing of leaves and yellowing and abscission of old leaves amounting to 10-15% (Northover and Schneider, 1991). Even at 0.5% concentration, cottonseed oil spray induces foliage burning on ‘Delicious’ apple trees (Rock and Carbtree, 1987). In addition, the rapid separation of oil emulsion after application leaves a greasy, sticky residue on trees, workers' clothes, and spray equipment, which makes the application difficult and unpleasant.

It is already well known that mono- and di-acylglycerols and phosphlipids are emulsifiers and have been widely used in producing food products (Krog, 1979; Henry, 1995; Weete et al., 1994; U.S. Pat. No. 5,160,759). The pending U.S. patent (Ser. No. 09/571,176) of the present inventors gives a composition and a method to prepare lipid emulsions by employing these emulsifiers. The inventors of the present invention found that all the glyceride type of lipids including mono-, di-, and tri-glycerides, phosphlipids, glycolipids, plant oils, and animal oils or fats acted as blossom thinning agents on fruit trees when sprayed on trees at prebloom to 50% full bloom phenophases. At application, glyceride type of lipids caused a discoloration on all flower petals but did not cause flower abscission. The late-developed lateral blossoms failed to open due to the injury while the early-developed flowers with higher vigor (king bloom) opened and developed normally even though their petals were also injured. The young fruits from the unopened flowers ceased growth soon after petal fall, and eventually abscised. The lipid emulsions left no greasy residue after application, and were not phytotoxic to fruit and trees. The inventors of this invention also found that surfactants such as polyoxyethylenesorbitan or polyoxyethylene ether products did not have thinning effects when applied alone at 1% or less, the concentrations of surfactants used in the present invention. Therefore, the thinning effect of the emulsion is caused by the lipids, not the surfactant, in the emulsion.

Compared with the currently used blossom thinners, the composition and the method of the present invention have the following advantages: (1) selective thinning. The emulsion in the present invention causes injury to petals of all flowers, but flowers with high vigor open and develop normally while the weak flowers fail to open. Thus, it ensures that only the weak flowers are thinned and the flowers with high vigor set fruit; (2) consistent thinning results. Emulsion in the present invention is effective and consistent in blossom thinning according to our 7 consecutive years of results. Since the emulsion achieves thinning by damaging flower petals and thus preventing flowers from opening, there are only two major factors that affect its thinning efficacy, lipid concentration and flower vigor, which are relatively easy to control; (3) broad applications. Most of the blossom thinners currently used are effective on pome trees but not on stone fruit trees (Hansen, 1999). The emulsion in the present invention, however, works well on both pome and stone fruit trees; (4) early application and early evaluation. Caustic blossom thinners must be applied relatively late (around 80% full bloom) to ensure enough fruit set and evaluation of thinning effects can not be made until at least 3 or 4 weeks after application. Therefore, it is often too late to use a post-bloom thinner when the fruit growers find that the blossom thinner has failed to thin adequately. The thinning effects of the compounds in the present invention, on the other hand, can be assessed by the percentage of damaged and unopened flowers at relatively early phenophases. If trees were thinned inadequately, a caustic blossom thinner or a post-bloom thinner could be easily followed; (5) non-phytotoxicity. While phytotoxicity is often a concern for caustic blossom thinners, the emulsion in the present invention does not cause fruit or foliage injury; and (6) environment and user friendly. Glyceride type of lipid is a nutrient. It is renewable and biodegradable. The emulsion prepared according to the present invention is stable, leaves no greasy, sticky residue, and is safe to human, beneficial insects, and the environment. By choosing the right compositions, lipid emulsions in the present invention are suitable for both conventional and organic fruit production programs.

Copper compounds are effective fungicides and bactericides and have been widely used in agriculture (Copper Development Association, 1948; Pscheidt and Ocamb, 1999). Their application as blossom thinning agent, however, has not been disclosed before. When applied at early blooming stages, we found that copper compounds desiccated flower petals and reduced fruit set. However, copper compounds caused leaf burning or fruit russet in a concentration dependent manner. When combined with the lipid emulsions of the present invention, the mixture displayed higher efficacy in thinning than either applied alone but did not cause phytotoxicity to trees.

(2) Fruit Cracking

Rain-induced cracking is one of the most serious problems to the sweet cherry industry around the world. In 1996, the loss due to rain-induced cracking of sweet cherries in New Zealand was about $3 million. In 1998, more than three-fourths of the sweet cherry crop in California was lost due to rain-induced fruit cracking, resulting in losses that exceeded $50 million (Long and Flore, 1999). Rain-induced fruit cracking is also a serious problem leading to crop loss in grapes (Considine and Kriedeman, 1972; Considine, 1973) and research in reducing fruit cracking of grapes has been unsuccessful (Considine, 1983). Skin cracking (checking, lenticel- or cuticle-cracking) is problematic to apple growers (Opara, 1996a, 1996b; Opara et al., 1997). The degree of cracks on affected fruit varies from barely noticeable to as much as 1.5 mm wide, which gives the fruit a rough feel and a russeted appearance. Although gibberellin, naphthaleneacetic acid, or daminozide reduced skin cracking in apples, these treatments are either inconsistent or caused negative effects such as poor skin finish or yield reduction (Costa et al., 1983; Byers et al., 1990).

Methods tested for controlling rain-induced cracking in cherries include foliar spray of calcium (Long and Flore, 1999; Marshall and Weaver, 1999), synthesized antitranspirants (Meherium et al., 1991), wetting agents (Kampe, 1971; Alani, 1980; Duhan and Pieber, 1981), or fatty acid esters (Ethyl oleate, Harrington et al., 1978). Although these treatments reduced fruit cracking in some instances, their applications in cherry production are limited due to inconsistent results or phytotoxicity related to repeated applications. As for skin cracking of apples, dipping attached fruit in Brytene 489-A, a wax solution, reduced crack development (Schrader and Haut, 1938). The waxed fruit, however, did not develop good color.

No prior art discloses that glyceride type of lipids can be used to reduce cracking of fruits. The inventors of this invention found when sprayed on trees, the glyceride type of lipid emulsion reduced rain-induced cracking of cherries and skin cracking of apples. Thus, the inventors of this invention provide an emulsion and a method that can be used to control cracking of fruits.

(3) Emulsion Preparation

In the present invention, the glyceride type of lipid emulsion is preferably prepared with vegetable oils, emulsifiers, surfactant, and water. The emulsifiers used in the present invention include purified mono- and di-acylglycerols, which are expensive in cost due to complicated separation and purification processes. Therefore, it is desirable to produce such lipid emulsifiers in a cheap way. It has been well known that mono- or di-acylglycerols can be produced by different methods such as partial esterification of free fatty acids with glycerol, partial hydrolysis of fatty triglycerides, or glycerolysis of triacylglycerols such as fats, oil, and methyl esters (Krog, 1979; Sonntag, 1982; U.S. Pat. Nos. 5,747,305 and 6,127,561). While these methods always produce a mixture of compounds, the purpose in the prior art to use these methods is to produce specific compounds and therefore, a serious of separation and purification process has to be followed. Direct usage of the mixture of compounds from the reaction without separation and purification has not been reported. Since all lipids from glyceride group are active ingredients in the present invention, we have found that all these methods can be employed and the mixtures of lipids from these reactions can be used to make a lipid concentrate or an emulsion directly. Therefore, no further separation and purification are needed and cost of the concentrate or the emulsion is greatly reduced. Accordingly, we provide a method that uses the above mentioned methods to produce a mixture of lipids and then uses this mixture, without separation and purification and without addition of emulsifier, to make a lipid concentrate or an emulsion, which can be used as blossom thinning agent or fruit cracking control agent.

### BRIEF SUMMARY OF INVENTION

The inventors of the present compounds found that glyceride type of lipids with the following formula (Formula I) acted as early blossom thinning agents on fruit trees and reduced cracking of fruits:

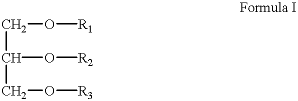

Wherein,

R₁ and R₂ are selected from the group comprising a hydrogen (H), an acyl or a derivative of the acyl. R₃ comprises an acyl, phosphonyl, phosphonylglycerol, phosphonylcholine, phosphonylethanolamine, phosphonylserine, phosphonylinositol, glycosyl, or a derivative from any one of them.

Specifically, glyceride type of lipids that conform to Formula I comprise mono-, di-, tri-glycerides, phospholipids, lysophospholipids, glycolipids, lysoglycolipids, plant oils, animal oil or fat, hydrogenated oils, and their derivatives.

Accordingly, the inventors of this invention provide a formulation and a method to make a concentrate or an emulsion with these lipids as active ingredients. The concentrate comprises glyceride type of lipid or lipids, emulsifier, and surfactant and the emulsion comprises glyceride type of lipid or lipids, emulsifier, surfactant, and water. The emulsifier, which is also a glyceride type of lipid and serves as active ingredient in this formulation, includes any mono-, di-glycerides, phospholipids, lysophospholipids, glycolipids, lysoglycolipids, or their derivatives. The surfactants include any type of siloxane, polysiloxane, and ionic or non-ionic surfactants. According to the method of this invention, the lipids comprise from approximately 1% up to 95% of the total emulsion, by volume; the emulsifier comprises from approximately 1% up to 95% of the total emulsion, by volume; the surfactant can comprise approximately 0% to 20% of the total emulsion, by volume; and the total active ingredients (sum of all lipids) can make up approximately 1% to 100% of the total emulsion. Water can comprise from 1% to 50% of the total emulsion, by volume. The lipid concentrate or the emulsion can be prepared by different methods including (1) mixing a lipid, an emulsifier, and a surfactant to form a lipid concentrate and (2) mixing a lipid, an emulsifier, a surfactant, and water to form an emulsion.

The inventors of the present invention further provide methods to produce emulsifier without involvement of separation and purification and to use the emulsifier or the mixture of lipids to make an emulsion. The methods include, but are not limited to, partial esterification of free fatty acids with glycerol, partial hydrolysis of fatty triglycerides, or glycerolysis of triglycerides such as fats, oil, and methyl esters. The emulsifiers or the mixture of lipids formed using the said methods are then used to make a concentrate or an emulsion.

According to the method of this invention, the lipid concentrate or the emulsion is further diluted with water to 0.5% to 10% active ingredients and applied on trees from popcorn (bud break) to full bloom stages, preferably at 0.5% to 5% active ingredients and applied between popcorn to 50% full bloom. For controlling cracking of fruits, emulsion at 0.5% to 5% active ingredients is sprayed on trees during any stage of fruit growth or when fruit are susceptible to cracking or before anticipated rain. The emulsion can be applied by any of the methods typically known and used in the agricultural industry for the application of a chemical. Preferably, the emulsion is applied by any common spraying technique used in the agricultural industry.

The inventors of the present compounds further found that copper compounds also acted as early blossom thinning agents on fruit trees but caused severe russets on fruit. When combined with the above mentioned lipid emulsions, however, the phytotoxicity of copper compounds was minimized and a synergetic effect in thinning between the copper compounds and the lipid emulsions was observed. Copper compounds in the present invention comprise Bordeaux mixture and fixed copper compounds, which include cupric acetate, cupric arsenite, cupric borate, cupric carbonate, cupric chloride, cupric chromate, cupric citrate, cupric formate, cupric hydroxide, cupric nitrate, cupric oleate, cupric phosphate, cupric salicylate, cupric stearate, cupric sulfate, or their derivatives.

Accordingly, the inventors of this invention provide a mixture and a method to apply the said lipid emulsion and copper compounds to fruit trees for blossom thinning. The mixture may be made by combining 100 L glyceride type of lipid emulsion at 0.5% to 10% active ingredients with copper compounds at 10 to 300 g metallic copper, preferably by combining 100 L lipid emulsion at 1.5% to 5% active ingredients and copper compounds at 30 to 100 g metallic copper. The mixture may be applied onto trees from popcorn (bud break) to full bloom stages, preferably applied between popcorn to 50% full bloom.

For the purpose of blossom thinning, the emulsions of the present invention can be applied, but are not limited to, pome fruit such as apple and pear trees and stone fruits such as peach, nectarine, plum, and cherry trees. It can also be used on citrus fruit, grapefruit, grapevines and other fruit trees. For the purpose of reducing cracking, the emulsions in the present invention can be applied, but are not limited to, cherry and apple trees. It can be used on other crops that are susceptible to cracking such as grapevines.

### BRIEF DESCRIPTION OF DRAWINGS

FIG. 1 is a graph of test results showing the effects of certain compositions of the present invention on the numbers of fruit per spur on ‘Bing’ cherry trees.

### DETAILED DESCRIPTION OF THE INVENTION

(1) Definitions

The term ‘emulsion’, as used herein, refers to a stable mixture of two or more immiscibles held in suspension.

The term ‘emulsifier’, in general, refers to compounds which reduce surface tension when dissolved in water or a water solution, or which reduce interfacial tensions between two liquids. Specifically, in the present invention it refers to a group of lipids, which comprise mono- and di-glycerides, phospholipids, lysophospholipids, glycolipids, lysoglycolipids, and their derivatives.

The term ‘surfactant’, as used herein, generally refers to surface active compounds which reduce surface tension when dissolved in water or a water solution, or which reduce interfacial tensions between two liquids. Specifically, in the present invention it refers to any surface-active agents other than the ‘emulsifier’ mentioned above.

The term ‘thinning agent’, as used herein, refers to any compound that reduces fruit set when applied on fruit bearing trees.

The term ‘popcorn’ or ‘budbreak’, as used herein, refers to a phenophase when petals of flower are swelling but not open.

The term ‘full bloom’, as used herein, refers to a phenophase when all flowers are open.

(2) Description

The inventors of the present compounds found that glyceride type of lipids with the following formula (Formula I) acted as blossom thinning agents on fruit trees and reduced cracking of fruits:

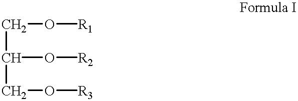

Wherein,

R₁ and R₂ are selected from the group comprising a hydrogen (H), an acyl or derivatives of the acyl. R₃ comprises an acyl, phosphonyl, phosphonylglycerol, phosphonylcholine, phosphonylethanolamine, phosphonylserine, phosphonylinositol, glycosyl, or a derivative from any one of them.

Glyceride type of lipids that conform to Formula I include mono-, di-, tri-glycerides, phospholipids, lysophospholipids, glycolipids, lysoglycolipids, plant oils, animal oil or fat, hydrogenated oils, and their derivatives.

The inventors of this invention also found that surfactants, such as polyoxyethylenesorbitan or polyoxyethylene ether, were not effective in thinning at 1% or less but caused some damage to leaf buds. This phytotoxicity, however, could be minimized by the presence of lipids in the formulation.

Therefore, the present invention provides a composition, which comprises glyceride type of lipid or lipids, emulsifier, surfactant, and water, for early bloom thinning of fruit trees and for reducing fruit cracking.

Accordingly, the present invention provides a method for early bloom thinning of fruit trees and reducing fruit cracking. The method comprises applying to said trees an emulsion that comprises glyceride type of lipid or lipids, emulsifier, surfactant, and water. The lipid in the emulsion could be any compound with Formula I, such as mono- di-, and tri-glycerides, phospholipids, lysophospholipids, glycolipids, lysophospholipids, plant oils, animal oils or fats, hydrogenated oils, their derivatives, or their mixture with any ratio, preferably a plant oil, an animal oil, or a mixture of plant oils or animal oils with any ratio. The emulsifier, which is also a glyceride type of lipid and serves as an active ingredient in this invention, includes any mono-, di-glyceride of fatty acids or fatty alcohols, phospholipids, lysophospholipids, glycolipids, lysoglycolipids, or their derivatives, preferably mono- and di-glycerides, phospholipids, or their mixture with any ratio. The surfactants include any type of siloxane, polysiloxane, and ionic or non-ionic surfactants. Examples of such surfactants are: lauryl sulfate or lauryl sulfate salts; polyether-polymethylsiloxane-copolymer (Break-Thru. RTM. OE441), manufactured by Goldschmidt Chemical Corporation; polyoxyethylenesorbitan, presently sold as the product family TWEEN and marketed by ICI Americas, Inc., of Wilmington, Del.; polyoxyethylene ethers, such as t-octylphenoxy-polyethanol, presently sold as the product family TRITON and marketed by Union Carbide Chemical and Plastics Co., Inc., of Danbury, Conn.; or alkylaryl polyoxyethylene glycols and alcohol, presently sold as Latron AG-98. Alternative surfactants with equivalent action to these typical products are also considered for use with the emulsion compound of the present invention.

Since the emulsifiers are also considered active ingredients for the compounds of the present invention, for the purposes of the present disclosure, especially in the tests and following discussions, the active ingredient concentration of the emulsion represents the total of all the glyceride type of lipids (including the emulsifier) in the emulsion.

According to the method of this invention, the glyceride type of lipids in the emulsion, preferably plant oils and animal oils, comprise from approximately 1% up to 95% of the total volume; the emulsifier, preferably monoglycerides or phospholipids, comprises from approximately 1% up to 95% of the total volume; the surfactant, preferably TWEEN products, can comprise approximately 0% to 20% of the total volume; and the total active ingredients (sum of all glyceride type of lipids) can make up approximately 1% to 100% of the total volume. Water can comprise from 1% to 99% of the total volume. Preferably, the emulsion is formed by plant oils, lipid emulsifier, surfactant, and water in a ratio of 4:1:1:4.

According to the method of this invention, the said emulsion can be prepared by the following methods: (1) The glyceride type of lipids is mixed with the emulsifier and surfactant, heated to 50-90 degrees C. with constant stirring until the mixture becomes a uniform phase, and cooled to room temperature (concentrate). After prolonged storage, the emulsifier may precipitate but the precipitation is physical and does not affect the property of the emulsion. Vigorous shaking, however, is required before use. At application, one part of the mixture is diluted with one or two parts of hot water (50-90 degrees C.) with vigorous stirring or shaking until a uniform white emulsion is formed. The emulsion is further diluted with tap water to appropriate concentrations; (2) The glyceride type of lipids is mixed with the emulsifier and surfactant, heated to 50 to 90 degrees C., and stirred vigorously while hot water (pre-heated to 50 to 90 degrees C.) is added. The mixture is stirred for another 5 min and then left at room temperature for slow cooling. The emulsion thus formed is further diluted with water at application; (3) Emulsifier is first prepared by glycerolysis of vegetable oil or animal oil or fat, which is done by the following method. To 5 to 30 parts by weight of glycerol, 1 to 20 parts by weight of sodium or potassium hydroxide are added with stirring. After the salt dissolved in the glycerol, 100 parts by weight of oil or fat are added to the solution with vigorous stirring. The mixture is heated to 100 to 250 degree C for 0.5 to 4 hours. The mixture thus formed comprises from 5% to 60% triglycerides, from 15% to 70% 1,3-diglycerides, from 1% to 40% 1,2-diglycerides and from 8% to 50% monoglycerides. Then the reaction is either stopped by adding phosphoric acid at the same molar as the sodium or potassium hydroxide or slowed done by adding 50 to 200 parts by weight of oil. After the temperature of the mixture cools down to 80 to 95 degree C., preheated surfactant and water are added with stirring to make an emulsion. The emulsion thus formed is further diluted with water at application; (4) When water is not added to the mixture produced as described in method (3), a lipid concentrate is formed. After prolonged storage, the emulsifier may precipitate from the lipid concentrate but the precipitation is physical and does not affect the property of the emulsion. Vigorous shaking, however, is required before use. At application, one part of the mixture is diluted with one or two parts of hot water (50-90 degrees C.) with vigorous stirring or shaking until a uniform white emulsion is formed. The emulsion is further diluted with tap water to appropriate concentrations; (5) The emulsifiers are produced by partial esterification of free fatty acids with glycerol. To one mole of glycerol, 1 to 2 mole of fatty acids is added. The mixture is heated to 100 to 250 degree C. for 1 to 4 hour at the presence of sulfuric acid. The reaction product is used for making a lipid concentrate or emulsion as described in method (1) or (2); and (6) The emulsifiers are produced by partial hydrolysis of fatty triglycerides. Plant oils and animal oils or fats are heated to 100 to 250 degree C at the presence of sodium hydroxide or potassium hydroxide for 1 to 4 hours. Then equal amount of phosphoric acid (50%) is added to the mixture and the aqueous phase containing free fatty acids is discarded. The partially hydrolyzed oils or fats are used for making a lipid concentrate or emulsion as described in method (1) or (2).

According to the method of this invention, the lipid concentrate or emulsion formed according to the above methods is further diluted with water at application. Emulsions containing 0.5% to 10% active ingredients are applied on trees from popcorn (bud break) to full bloom stages, preferably, emulsions containing 2% to 5% active ingredients are applied between popcorn to 50% full bloom. For controlling cracking of fruits, the emulsions containing 0.5% to 10 active ingredients, preferably 0.5% to 3% active ingredients, are sprayed on trees during any stage of fruit growth or when fruit are susceptible to cracking or before anticipated rain. Those skilled in the art will appreciate that the optimum time for thinning is determined by the emulsion concentration intended for use, the particular species or cultivar, and the vigor of the trees and flowers. For controlling fruit cracking, the optimum time of application is the development stages when fruit are most susceptible to cracking. While a single application of the emulsion should be satisfactory for effective thinning or cracking control, those skilled in the art will also appreciate that multiple applications may be employed to achieve a desired thinning effect or cracking control. The emulsion can be applied by any of the methods typically known and used in the agricultural industry for the application of a chemical. Preferably, the emulsion is applied by any common spraying technique used in the agricultural industry.

The inventors of the present compounds further found that copper compounds also acted as early blossom thinning agents on fruit trees but caused severe russets on fruit. When combined with the glyceride type of lipid emulsion of the present invention, however, the phytotoxicity of copper compounds was minimized and a synergetic effect in thinning between the copper compounds and the emulsion was observed. Copper compounds in the present invention comprise Bordeaux mixture and fixed copper compounds, which include cupric acetate, cupric arsenite, cupric borate, cupric carbonate, cupric chloride, cupric chromate, cupric citrate, cupric formate, cupric hydroxide, cupric nitrate, cupric oleate, cupric phosphate, cupric salicylate, cupric stearate, cupric sulfate, or their derivatives.

Accordingly, the inventors of this invention provide a mixture of glyceride type of lipid emulsion and copper compounds and a method to apply the said mixture onto fruit trees for blossom thinning. According to the method of this invention, the mixture may be made by combining 100 L emulsion containing 0.5% to 10% active ingredients with copper compounds at 10 to 300 g metallic copper, preferably by combining 100 L emulsion containing 1.5% to 2.5% active ingredients and copper compounds at 30 to 100 g metallic copper. The mixture may be applied on trees from popcorn (bud break) to full bloom stages, preferably applied between popcorn to 50% full bloom.

For the purpose of blossom thinning, the emulsions of the present invention can be applied to, but are not limited to, pome fruit such as apple and pear trees and stone fruit such as peach, nectarine, plum, and cherry trees. It can also be used on citrus fruit, grapefruit, grapevines and other fruit trees. For the purpose of reducing cracking, the emulsions in the present invention can be applied to, but are not limited to, cherry and apple trees. It can be used on other crops that are susceptible to cracking such as grapevines.

(3) LIST OF EXAMPLES

The following examples are offered to illustrate, but not to limit the claimed invention.

Example 1. Preparation of emulsion with glyceride type of lipids

Example 2. Glyceride type of lipids for early bloom thinning on pome and stone fruit trees

Example 3. Glyceride type of lipids for early bloom thinning on cherry trees

Example 4. Glyceride type of lipids and surfactants for early bloom thinning on pome and stone fruit trees

Example 5. Thinning effects and phytotoxicity of glyceride type of lipid, copper compounds, and their mixture

Example 6. Glyceride type of lipids for controlling rain-induced cracking of cherry fruit

Example 7. Glyceride type of lipids for controlling skin cracking of ‘Fuji’ apples

Experiments were conducted from 1993 until 1999 in commercial orchards. Except as indicated, glyceride type lipids utilized for the following tests were oils or fats, monoacylglycerols, diacylglycerols, triacylglycerol, phospholipids, and glycolipids. Oils and fats included plant (corn, soybean, peanut, canola, linseed, safflower, sunflower, rapeseed, cottonseed) oil, hydrogenated corn and soybean oil, fish oil, and lard; Monoacylglycerol included monolaurin, monolinoleoyl-rac-glycerol, monooleoyl-rac-glycerol and monostearoyl-rac-glycerol; Di-acylglycerol included 1,2-dipalmitoyl-rac-glycerol, 1,2-dileoyl-rac-glycerol, and 1,3-dilinoleoglycerol; Triacylglycerols included 1,2-dipalmitoyl-3-myristoyl-rac-glycerol, 1,2-dilinoleoyl-3-palmitoyl-rac-glycerol, 1,2-dilinoleoyl-3-oleoyl-rac-glycerol, and glycerol trioleate; Phospholipids included phosphatidylcholine, phosphatidylethanolamine, phosphetidylserine, phosphatidylinostol, lysophosphatidylcholine, lysophosphatidylethanolamine, lysophosphetidylserine and lysophosphatidylinostol; and glycolipids included mono- and di-galactosyldiacylglycerol. The lipids were either tested individually or combined in an emulsion as described below. Copper compounds tested in the present invention included Bordeaux mixture and fixed copper compounds such as cupric acetate, cupric arsenite, cupric borate, cupric carbonate, cupric chloride, cupric chromate, cupric citrate, cupric formate, cupric hydroxide, cupric nitrate, cupric oleate, cupric phosphate, cupric salicylate, cupric stearate, and cupric sulfate.

### EXAMPLE 1

Preparation of Emulsions with Glyceride Type of Lipids

Emulsion I was prepared by mixing 4 parts corn or soybean oil, 1 part monostearoyl-rac-glycerol, and 1 part TWEEN 60 by volume, heating the mixture to 90 degrees C., and adding 4 parts hot water (pre-heated to 90 degrees C) to the mixture with stirring. The water-in-oil emulsion thus formed was then left at room temperature for slow cooling. The emulsions thus prepared were then diluted with water to the application rate, 1%, 2.5%, and 5% of active ingredient. Both the mother emulsions and the diluted emulsions were used for stability evaluation.

Emulsion II was prepared by dissolving 0.3 grams of sodium hydroxide in 14 grams of glycerol and then adding 100 grams of commercial corn or soybean oil. With vigorous stirring, the mixture was heated to 200 degree C. for 1 hour. The reaction mixture was shown by thin layer chromatographic analysis to contain 22% triglycerides; 30% 1,3-diglycerides; 20% 1,2-diglycerides; 1% free fatty acid; 2% 2-monoglycerides; and 25% 1-monoglycerides. To the mixture, 200 grams of soybean oil was added and after the temperature of the mixture reached to 95 degree C., 15 grams of Tween 60 and 250 grams of preheated water was added to make the emulsion. The emulsions thus prepared were then diluted with water to the application rate, 1%, 2.5%, and 5% of active ingredient. Both the mother emulsions and the diluted emulsions were used for stability evaluation.

Stability of the mother emulsions was evaluated by measuring conductivity and by visual evaluation of the emulsion according to the method of Womack et al. (1996). An ammeter was used to verify the emulsion type by measuring the current passing between two electrodes immersed in the emulsion. Measurements were made at preparation and every day for the two weeks. A zero reading represented a continuous oil phase in the emulsion. The higher reading represented that the emulsion is not an uniform water-in-oil emulsion. To visually evaluate its stability, both the mother emulsions and their diluted solutions were sealed in a 100-ml glass container at 20 degree C. and the stability of the emulsions was evaluated as breaking, creaming, or inversion every day for 30 days.

Both Emulsion I and II gave a zero reading and appeared as a uniform water-in-oil emulsion visually during the test period. Visual evaluation also showed that when diluted with water, both Emulsion I and II were very stable during the testing period (data not shown). No difference was found in stability between corn oil emulsion and soybean oil emulsion.

### Example 2

Glyceride Type of Lipids for Early Bloom Thinning on Pome and Stone Fruit Trees

Emulsions containing 4 parts corn or soybean oil, 1 part purified emulsifier, 1 part surfactant, and 4 parts water, by volume, were prepared as described in Example 1. Emulsions containing 1%, 2%, 3%, and 5% active ingredients and a water control were sprayed onto trees at 4 to 5% full bloom (FB). Each treatment consisted of 4 trees (replications) in a row (oriented from south to north) and 2 shoots (one from the east and another from the west side of the canopy) were selected from each of the 4 trees for evaluation. Fruit set was measured 2 months after FB. Leaf damage was evaluated 1, 2, and 3 weeks after application, and return bloom was evaluated the following season. Trees received standard commercial management both before and after oil application.

Emulsions made from corn oil or soybean oil showed similar efficacy, which increased as lipid concentration increased, and the linear relationship was significant (Table 1). At 2% to 3%, the lipid emulsions thinned to a satisfactory level. Lipid emulsion treatments did not affect return bloom or cause fruit or foliage injury at any concentration or at any application time in any cultivar (data not shown).

TABLE 1
Effects of glyceride type of lipids on fruit set (%) in
pome and stone fruit trees.

| | Cultivar | | | | | |
|---|---|---|---|---|---|---|
| Lipid | | | ‘Xiang | ‘Fei- | ‘S. | ‘H. |
| (%) | ‘Delicious’ | ‘Fiji’ | Shui’ | cheng’ | Grand’ | Sun’ |
| 0 | 85 | 76 | 89 | 72 | 81 | 74 |
| 1 | 67 | 60 | 75 | 52 | 64 | 71 |
| 2 | 36 | 41 | 46 | 48 | 37 | 43 |
| 3 | 24 | 21 | 31 | 28 | 24 | 27 |
| 5 | 11 | 15 | 20 | 17 | 21 | 18 |
| Regression^{Z} | **** | **** | **** | **** | **** | **** |
| Linear | | | | | | |

^{Z}****or NS represent, respectively, significant at P ≦ 0.0001 or nonsignificant.

### Example 3

Glyceride Type of Lipids for Early Bloom Thinning on Cherry Trees

Emulsions were prepared with glyceride type of lipids as described in Example 2. The experiment consisted of a randomized complete block design with 16 plots, which included all combinations of four lipid concentrations (1%, 3%, and 5% and water control) and four application times (bud break or popcorn, 20%, 50%, and 80% full bloom), in each of three blocks. Each treatment (plot) consisted of two rows with 4 trees in each row, which received standard commercial management both before and after oil application. In each treatment, 3 trees (replicates) were used and 6 shoots were selected from each tree for fruit set evaluation, which was presented as fruit number/100 bloom clusters. Return bloom was evaluated the following season. Fruit weight, soluble solids, and total yields of cherries were measured at harvest. Fruit weight was measured using all fruit from the 6 shoots of each tree. Soluble solids contents were measured using a combined sample of juice extracted from 20 fruit in each replicate. Total yields were measured using all fruit from each tree.

The effectiveness of bloom thinning increased accompanying the increase of lipid concentration (Table 2). Corn oil or soybean oil emulsion showed similar efficacy. At the same concentration, the emulsions were equally effective when applied at bud break or 20% FB. The emulsions were less effective when applied at 50% FB and not effective at 80% FB even at high concentrations.

TABLE 2
Effects of glyceride type of lipids on fruit set (%) of ‘Bing’
cherry trees.

| Lipid | Stages of flower development | | | | |
|---|---|---|---|---|---|
| concentration | Bud | 20% | 50% | 80% | Regression |
| (%) | break | FB | FB | FB | Linear |
| 0 | 94 | 91 | 96 | 91 | NS |
| 1 | 81 | 87 | 92 | 94 | ** |
| 3 | 53 | 52 | 81 | 93 | **** |
| 5 | 23 | 27 | 77 | 89 | **** |
| Regression^{Z} | **** | **** | ** | NS | |
| Linear | | | | | |

^{Z}****, **, N.S. represent, respectively, significance at P ≦ 0.0001, 0.001 or nonsignificance.

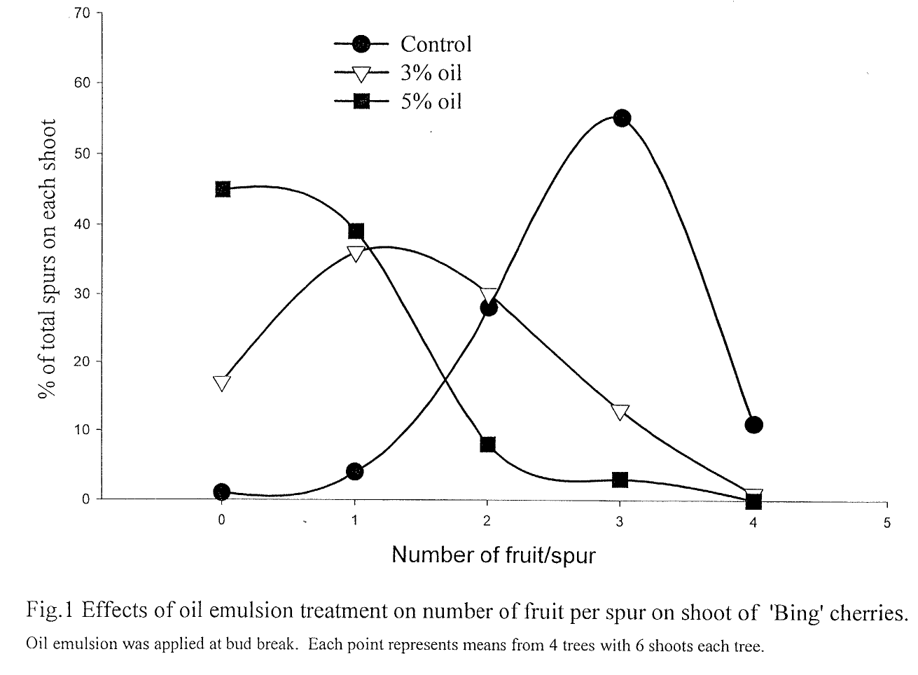

The distribution of fruit number per spur shifted from double and triple on the controls to single and double on the 3% lipid-treated fruit trees (FIG. 1). When applied at 5%, however, emulsion treatments caused further shift to zero and single fruit per spur. Although the lipid treatments reduced total yield, they increased fruit weight and soluble solids significantly (Table 3).

Emulsion treatments did not affect return bloom or cause fruit or foliage injury at any concentrations or at any application time in any cultivar (data not shown).

TABLE 3
Effects of glyceride type of lipid applied at 20%
full bloom on ‘Bing’ cherries^{y}.

| Lipid | | | Soluble solids |
|---|---|---|---|
| concentration | Fruit weight | Total yield | contents |
| (%) | (g) | (Kg) | (%) |
| 0 | 5.8 | 23.6 | 20.1 |
| 1 | 6.0 | 24.6 | 20.4 |
| 3 | 7.7 | 19.8 | 21.3 |
| 5 | 8.2 | 14.5 | 21.7 |
| Regression | **** | **** | **** |
| Linear | | | |

^{Z}**** or NS represent, respectively, significance at P ≦ 0.0001 or nonsignificance.

### Example 4

Glyceride Type of Lipids and Surfactants for Bloom Thinning on Pome and Stone Fruit Trees.

To test the effect of surfactant on bloom thinning, TWEEN 60 or TRITON X-100 solution at 0.2%, 0.6%, and 1% (the same surfactant concentrations of the lipid emulsions in Examples 2 and 3) were compared with the lipid emulsions containing 1%, 3%, and 5% active ingredients. Fruit trees of ‘Feng Huang’ peaches, ‘Delicious’ apples, and ‘Bing’ cherries all were sprayed at 5% full bloom. Each treatment (plot) consisted of 4 trees, which received standard commercial management both before and after oil application.

Emulsions at 1%, 3%, and 5% active ingredients (containing 0.2%, 0.6%, or 1% surfactant, respectively) showed thinning effects in a concentration dependent manner without causing any phytotoxicity (Table 4). TWEEN 60 or TRITON X-100 at the application rate were not effective in thinning but caused some damage to leaf buds at 0.6% or 1%.

Therefore, it is the lipids not the surfactants in the emulsion that are responsible for the thinning effect and the presence of lipids in the emulsion counteracts the phytotoxicity of surfactants.

TABLE 4
Effects of glyceride type of lipids and surfactants applied at bud
break on fruit set (%) and leaf bud damage (%) of ‘Delicious’
apple, ‘Feng Huang’ peach, and ‘Bing’ cherry trees.

| | ‘Delicious’ | | ‘Feng Huang’ | | ‘Bing’ | |
|---|---|---|---|---|---|---|
| Treatment (%) | Fruit set | Damage | Fruit set | Damage | Fruit set | Damage |
| Corn oil | | | | | | |
| 0 | 64 | 0 | 42 | 0 | 89 | 0 |
| 1 | 67 | 0 | 39 | 0 | 74 | 0 |
| 3 | 26 | 0 | 21 | 0 | 53 | 0 |
| 5 | 18 | 0 | 13 | 0 | 23 | 0 |
| Regression^{Z} | **** | | **** | | **** | |
| Linear | | | | | | |
| TWEEN 60 | | | | | | |
| 0 | 67 | 0 | 40 | 0 | 90 | 0 |
| 0.2 | 58 | 0 | 46 | 0 | 96 | 0 |
| 0.6 | 65 | 7 | 42 | 5 | 92 | 8 |
| 1.0 | 61 | 13 | 38 | 18 | 87 | 17 |
| Regression | NS | **** | NS | **** | NS | **** |
| Linear | | | | | | |
| TRITON | | | | | | |
| X-100 | | | | | | |
| 0 | 77 | 0 | 47 | 0 | 91 | 0 |
| 0.2 | 62 | 0 | 41 | 0 | 94 | 0 |
| 0.6 | 64 | 8 | 42 | 6 | 83 | 10 |
| 1.0 | 69 | 15 | 38 | 20 | 90 | 18 |
| Regression | NS | **** | NS | **** | NS | **** |
| Linear | | | | | | |

^{Z}****, *** or NS represents, respectively, significant at P ≦ 0.0001, 0.001, or non-significant.

### Example 5

Thinning and Phytotoxicity of Lipid, Copper Compounds, and their Mixture

Emulsion was prepared with glyceride type of lipids as in Example 2 and diluted to 2% active ingredients. Cupric sulfate was added to the diluted emulsion to give mixtures containing 0, 50, 100, and 150 g metallic copper per 100 L, respectively. Aqueous solutions containing 0, 50, 100, and 150 g metallic copper per 100 L were also prepared seperately. Emulsion and copper mixtures or cupric sulfate solutions were sprayed on 12 year-old ‘Gala’ apple trees at 5% FB. Each treatment consisted of 4 trees (replications) in a row (oriented from south to north) and 2 shoots (one from the east and another from the west side of the canopy) were selected from each of the 4 trees for evaluation. Fruit set was measured 2 months after FB and leaf damage were evaluated 1, 2, and 3 weeks after application. Fruit russet was assessed at harvest and return of bloom was evaluated the following season.

Cupric sulfate showed both thinning and phytotoxicity in a concentration dependent manner (Table 5). When combined with the lipid emulsion, thinning effect was enhanced while the phytotoxicity caused by copper was reduced. Only slight russet was found on fruit treated by the highest copper concentration.

TABLE 5
Thinning and pytotoxicity caused by copper (g metallic copper/100 L)
or a mixture of 2% lipid emulsion plus copper on ‘Gala’ apples.

| | Cupric sulfate | | | Lipid and copper mixture | | |
|---|---|---|---|---|---|---|
| | Thin- | Leaf | | Thin- | Leaf | |
| | ning | damage | Russet | ning | damage | Russet |
| Copper | (%) | (%) | (%) | (%) | (%) | (%) |
| 0 | 93 | 0 | 0 | 57 | 0 | 0 |
| 50 | 87 | 0 | 0 | 42 | 0 | 0 |
| 100 | 64 | 9 | 35 | 28 | 0 | 0 |
| 150 | 43 | 24 | 64 | 16 | 0 | 3 |
| Regression | **** | **** | **** | **** | NS | NS |
| Linear | | | | | | |

^{Z}**** or NS represent, respectively, significance at P ≦ 0.0001 or nonsignificance.

### Example 6

Glyceride Type of Lipids for Controlling Rain-Induced Cracking of Cherry Fruit

Emulsions prepared with glyceride type of lipids as in Example 2 were diluted into 1, 3, or 5% active ingredients and were sprayed on ‘Bing’ cherry trees 30, 20, 10, and 5 days before harvest, respectively, using low-pressure hand wand sprayers until run off. Since water may increase cracking, untreated trees served as control. Rain (about 25 mm) occurred 8 days before harvest. Cracking was evaluated and recorded as percent incidence at harvest.

Emulsion treatments reduced cracking in a lipid concentration dependent manner (Table 6). Corn oil and soybean oil emulsion was equally effective. Application before rain was more effective in protecting cherries from cracking than application after rain.

TABLE 6
Effects of glyceride type of lipids on rain-induced cracking (%)
of “Bing” cherries.

| Lipid | Application time (Days before harvest) | | | | |
|---|---|---|---|---|---|
| concentration | 30 | 20 | 10 | 5 | ANOVA |
| Control | 32 a | 28 a | 31 a | 36 a | NS |
| 1% | 24 b | 21 b | 12 b | 31 a | ** |
| 3% | 14 c | 11 c | 3 c | 24 b | ** |
| 5% | 8 c | 5 c | 4 c | 18 b | ** |

^{Z}Mean separation in the same column by Duncan' new multiple range tests at p < 0.01.

### Example 7

Glyceride Type of Lipids for Controlling Skin Cracking of ‘Fuji’ Apples

Emulsions prepared with glyceride type of lipids as in Example 2 were diluted into 1, 3, or 5% active ingredients and were sprayed onto ‘Fuji’ apple trees 60, 45, 30, and 15 days before harvest, respectively, using low-pressure hand wand sprayers until run off. Trees treated with the same amount of water served as control. Cracking was evaluated and recorded as percent incidence at harvest.

Lipid treatments reduced cracking in a lipid concentration dependent manner (Table 7). Corn oil or soybean oil emulsion was equally effective. Application during the period of rapid fruit growth (60 to 30 days before harvest) was more effective than application 15 days before harvest.

TABLE 7
Effects of glyceride type of lipids on skin cracking (%)
of ‘Fuji’ apples.

| Lipid | Application time (Days before harvest) | | | | |
|---|---|---|---|---|---|
| concentration | 60 | 45 | 30 | 15 | ANOVA |
| Control | 18 a | 21 a | 17 a | 16 a | NS |
| 1% | 14 b | 11 b | 10 b | 19 a | ** |
| 3% | 10 b | 5 c | 8 bc | 11 b | ** |
| 5% | 4 c | 0 c | 1 d | 9 bc | ** |

^{z}Mean separation in the same column by Duncan's new multiple range tests at p < 0.01.
ANOVA represents comparison in the same row.

In compliance with the statutes, the invention has been described in language more or less specific to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the claims, as appropriately interpreted in accordance with the doctrine of equivalents.

We claim:

1. A composition for early bloom thinning of fruit trees and controlling cracking of fruits, the composition comprising:
glyceride type of lipid or lipids, emulsifier, surfactant and water;

2. The composition of claim 1, wherein the glyceride type of lipid has the formula 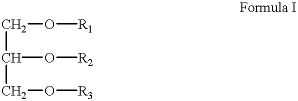
wherein,
R₁, and R₂ are selected from the group consisting of a hydrogen, an acyl, or a derivative from the acyl; R₃ is a group of any acyl, glyceryl, glycosyl, phosphonyl, phosphonylcholine, phosphonylethanolamine, phosphonylserine, phosphonlyinositol, phosphonylglycerol, or a derivative from any one of them;

3. The composition of claim 1, wherein the glyceride type of lipid is one compound or a mixture of compounds with any ratio, preferably a plant or animal oil or a mixture of plant oils or animal oils with any ratio.

4. The composition of claim 1, wherein the emulsifier, which is also an active ingredient in the composition, is a glyceride type of lipid or a mixture of glyceride type of lipids chosen from the group comprising mono- and di-glycerides, phospholipids, lysophospholipids, glycolipids, lysoglycolipids, or their derivatives, preferably monoglycerides, phospholipids, or their mixture.

5. The composition of claim 1, wherein the surfactant is chosen from the group comprising lauryl sulfate, siloxanes, polysiloxanes, polyoxyethylene ethers, polyoxyethylenesorbitan, alkylaryl polyoxyethylene glycols and alcohol, and any other ionic or nonionic surfactants.

6. The composition of claim 1, wherein the glyceride type of lipid comprises from approximately 1% up to 95% of the total volume; the emulsifier comprises from approximately 1% up to 95% of the total volume; the surfactant comprises from approximately 0% up to 20% of the total volume; the total active ingredients (including emulsifier) comprises from approximately 1% up to approximately 100% of the total volume; and water comprises from 1% up to 99% of the total volume.

7. The composition of claim 1, wherein the glyceride type of lipid or lipids, the emulsifier, the surfactant and the water are present preferably in a volume to volume ratio of approximately 4:1:1:4.

8. A method for bloom thinning of fruit trees and controlling cracking of fruits, the method including the steps of:
a) mixing glyceride type of lipid or lipids, emulsifier, surfactant, and/or water to form an concentrate or emulsion, or first producing an emulsifier or a mixture of lipids by partial esterification of free fatty acids with glycerol, partial hydrolysis of fatty triglycerides, or glycerolysis of triacylglycerols such as fats, oil, and methyl esters and then mixing the emulsifier or the mixture of lipids with surfactant and/or water to form concentrate or an emulsion.
b) diluting said concentrate or emulsion with water to appropriate concentration.
c) applying an effective amount of the diluted emulsion at appropriate phenophases to fruit trees.

9. The method of claim 8, wherein the step of mixing the glyceride type of lipid with the emulsifier, the surfactant, and water further includes the step of heating the resultant mixture to 50-95° C.

10. The method of claim 8, wherein the emulsion is prepared by directly using the mixture of lipids produced from partial esterification of free fatty acids with glycerol, partial hydrolysis of fatty triglycerides, or glycerolysis of triacylglycerols such as fats, oil, and methyl esters without separation and purification.

11. The method of claim 8, wherein the effective amount of emulsion applied to trees includes a concentration of active ingredients (including emulsifier) at 0.5% to 10%, preferably at 0.5% to 5%.

12. The method of claim 8, wherein the application phenophases for blossom thinning are from bud break (popcorn) to full bloom, preferably from bud break to 50% full bloom.

13. The method of claim 8, wherein the application phenophase for controlling rain-induced cracking of cherries is anytime when fruit are susceptible to cracking, preferably starting from one month before harvest or at any time before forecasted rain.

14. The method of claim 8, wherein the application phenophase for controlling skin cracking of apple is anytime when fruit are susceptible to cracking, preferably starting from the phenophase in which fruit have rapid growth.

15. The method of claim 8, wherein the fruit trees for blossom thinning include pome, stone, citrus, grapefruit, and grapevine.

16. The method of claim 8, wherein the fruit trees for cracking control include apples, cherries, grapes, and berries.

17. A method for early bloom thinning of fruit trees, wherein said method includes applying an effective amount of copper compounds or an effective amount of copper compounds in combination with an emulsion made from glyceride type of lipids to fruit trees at appropriate phanophases.

18. The method of claim 17, wherein the copper compounds are selected from the group comprising Bordeaux mixture and fixed copper compounds, which include cupric acetate, cupric arsenite, cupric borate, cupric carbonate, cupric chloride, cupric chromate, cupric citrate, cupric formate, cupric hydroxide, cupric nitrate, cupric oleate, cupric phosphate, cupric salicylate, cupric stearate, cupric sulfate, or their derivatives.

19. The composition of claim 17, wherein the effective amount of copper compounds includes a concentration of 10 to 300 grams metallic copper per 100 liter solution, preferably 50 to 150 grams metallic copper per 100 liter solution.

20. The composition of claim 17, wherein the effective amount of glyceride type of lipid emulsion includes a concentration of 0.5% to 10%, preferably 0.5% to 3% active ingredients.

21. The method of claim 17, wherein the appropriate application phenophases for blossom thinning are from bud break (popcorn) to full bloom, preferably from bud break to 50% full bloom.

22. The method of claim 17, wherein the fruit trees include pome, stone, citrus, grapefruit, and grapevine.
